(19) United States
(12) Patent Application Publication
(10) Pub. No.: US 2023/0331292 A1
(43) Pub. Date: Oct. 19, 2023

(54) Steering System for a Vehicle, in Particular a Utility Vehicle

(71) Applicant: KNORR-BREMSE Systeme fuer Nutzfahrzeuge GmbH, Muenchen (DE)

(72) Inventor: Mario LUEBSTORF, Wuelfrath (DE)

(21) Appl. No.: 18/028,615

(22) PCT Filed: Aug. 26, 2021
(86) PCT No.: PCT/EP2021/073651

§ 371 Date: Mar. 27, 2023

(30) Foreign Application Priority Data
Sep. 28, 2020 (DE) 10 2020 125 258.7

(51) Int. Cl. B62D 5/04; B62D 3/06

(52) U.S. Cl. CPC B62D 5/0418; B62D 5/0421; B62D 3/06

(57) ABSTRACT

A steering system for a vehicle, in particular a utility vehicle, has at least one first steering gear and at least one first steering mechanism for steering at least one first vehicle wheel. The first steering gear is coupled to the first steering mechanism. The steering system has at least one second steering gear and at least one second steering mechanism for steering at least one second vehicle wheel. The second steering gear is coupled to the second steering mechanism. At least one tensioning mechanism is coupled to the first steering gear and to the second steering gear such that the first steering gear and the second steering gear are pre-tensionable with respect to each other, in particular in the idle state and oppositely.

### BACKGROUND AND SUMMARY

The present invention relates to a steering system for a vehicle, in particular a utility vehicle, having at least one first steering gear and having at least one first steering mechanism for steering at least one first vehicle wheel, wherein the first steering gear is coupled to the first steering mechanism, having at least one second steering gear and having at least one second steering mechanism for steering at least one second vehicle wheel, wherein the second steering gear is coupled to the second steering mechanism, and having at least one tensioning mechanism.

Steering systems for vehicles, in particular for utility vehicles, will be subject to ever increasing functional requirements in the future, since the steering system plays a central role in the (partial) automation of vehicles.

It is particularly important here that the steering system functions precisely and reliably, satisfies these increasing functional requirements and may still be further optimized in terms of the required installation space.

Steering systems for vehicles are already known from the prior art.

In this regard, DE 10114600 A1 discloses a vehicle steering having a steering control device, in particular a steering wheel, which can be operated by the driver, an electromechanical actuating unit for controlling a steerable right and left wheel of a wheel pair of a steerable vehicle axle on a vehicle body, means, which, in the event of a failure or malfunction of one of the two actuating units associated with a steerable vehicle axle, ensure that the two vehicle wheels of this vehicle axle are controlled by means of the other, still functional actuating unit in each case.

DE 112012806263 T5 furthermore discloses a vehicle steering device containing: a steering device, which is configured to rotate a steered wheel according to the operation of a vehicle steering wheel, wherein the steering device contains a first motor and a second motor for steering purposes, which have common electrical characteristics; a first current sensor, which is configured to detect a first current value of a current flowing through the first motor; a second current sensor, which is configured to detect a second current value of a current flowing through the second motor; and abnormality diagnostics units.

Such steering devices from the prior art are still complex and composed of many components, need a large installation space and are heavy.

The object of the present invention, therefore, is to advantageously develop a steering system of the type mentioned at the outset, in particular such that the steering system is designed with redundancy, is less heavy, can be cost-effectively produced and implements steering commands at the vehicle wheels in a more precise manner.

This object is achieved according to the invention by a steering system having the features of the independent claim. It is accordingly provided that a steering system for a vehicle, in particular a utility vehicle, having at least one first steering gear and having at least one first steering mechanism for steering at least one first vehicle wheel, wherein the first steering gear is coupled to the first steering mechanism, having at least one second steering gear and having at least one second steering mechanism for steering at least one second vehicle wheel, wherein the second steering gear is coupled to the second steering mechanism, and having at least one tensioning mechanism is provided, which is coupled to the first steering gear and to the second steering gear in such a way that the first steering gear and the second steering gear are pre-tensionable with respect to each other, in particular in the idle state and oppositely.

The invention is based on the basic idea that the steering system has two independent steering gears, so that the steering system is designed as a redundant steering system. The first and second steering gear are furthermore coupled to each other via a tensioning mechanism, which pre-tensions the two steering gears. The advantage or idea behind this pre-tension is that the steering play in the two steering gears and the first and steering mechanisms coupled thereto may be removed or compensated. The steering system may thus operate more precisely, so that the operational reliability of the steering system on the one hand, and of the vehicle or utility vehicle on the other, is improved. In normal operation, the tensioning mechanism serves exclusively to pre-tension both steering gears and not to transmit steering movements from the first to the second steering gear, or vice versa. In particular, the first steering gear and the second steering gear here are pre-tensionable with respect to each other in the idle state and oppositely. In the event of a failure of the first and/or second steering gear, the tensioning mechanism, in addition to its function as a play-compensating element, serves as a driver to transmit the steering movements of the still intact first or second steering gear to the first or second steering mechanism and to therefore continue to reliably ensure the steerability of both vehicle wheels.

Moreover, it may be provided that the tensioning mechanism is linked to the first steering mechanism and to the second steering mechanism. According to the present invention, the first and second steering mechanism are designed as a linkage with one or more joints, which connects the respective track rods to the first and second steering gear. The tensioning mechanism may therefore be connected or coupled to the first and second steering mechanism in a very simple manner. It is consequently possible to dispense with steering components which are costly and difficult to produce, such as steering racks, so that a cost-effective steering system can be provided. However, the tensioning mechanism is the only mechanical connecting or coupling element between the first and second steering mechanism, since, in normal operation, these steering mechanisms are driven independently of each other by the first or second steering gear.

It is furthermore contemplated that the tensioning mechanism, in the mounted state, is elastically pre-tensionable and/or pre-tensioned. This type of elastic and mechanical pre-tension offers a structurally very simple and reliable option for pre-tensioning the two steering mechanisms and steering gears with respect to each other, since there is no need to provide an additional component in order to ensure the pre-tension. This solution is moreover very cost-effective and light. The tensioning mechanism here may be designed in particular as an elastically pre-tensionable and/or pre-tensioned tension rod, tie rod, tensioning strut, draw tube, tie beam or vise.

It is moreover contemplated that the tensioning mechanism comprises at least one longitudinal adjustment mechanism and/or telescopic mechanism. The pre-tension may thus be set in a particularly precise manner. This is particularly advantageous because too high a pre-tension would represent a mechanical load for the two steering mechanisms and steering gears and shorten their service life. However, too low a pre-tension is likewise disadvantageous since the effect of substantially entirely removing the play in the steering system would then be negated. In this regard, the precise setting of the pre-tension by means of the tensioning mechanism is very important for a reliably functioning steering system according to the present invention.

It is additionally possible that the tensioning mechanism comprises at least one elastic spring element. By means of the spring element, important parameters such as: pre-tensioning force, damping characteristic, pre-tensioning distance, pre-tensioning direction and pre-tensioning elasticity of the tensioning mechanism may be set specifically for the respective steering system so that a good compromise between too much and too little pre-tension can be addressed by selecting the appropriate elastic spring element. In combination with the longitudinal adjustment mechanism and/or telescopic mechanism, the elastic spring element is particularly advantageous because the above-described parameters can thus be set even more precisely.

It may furthermore be provided that the elastic spring element is designed as an axial spring element. By providing an axial spring element, the above-described parameters can therefore be set in a very simple manner since the tensioning mechanism according to one exemplary embodiment of the present invention may be designed as a rigid rod-shaped, beam-shaped or bar-shaped element (i.e. its length is considerably longer than its height and width). The tensioning mechanism therefore realizes its pre-tensioning function or effect substantially in the axial direction in combination with the axial spring element, as described above.

It is likewise contemplated that the elastic spring element is designed as a radial spring element, in particular a leaf spring element. By means of the radial spring element, the pre-tension of the tensioning mechanism may be implemented in a structurally very simple and weight-reducing manner using very few components, since leaf spring elements, for example, are very simple, yet also very reliable and well-engineered mechanical elements with clearly defined elastic properties. The radial spring element therefore represents a very efficient and reliable component for forming the tensioning mechanism since, if need be, it can be constructed from only one component.

It is moreover contemplated that the second steering gear is designed to be smaller than the first steering gear in at least one dimension. The second steering gear, which is also referred to as a so-called “power pack”, is not mechanically connected to a vehicle steering wheel and a steering column, which means that it is activated exclusively via a control and/or regulating device. Therefore, in the case of the second steering gear, it is possible to dispense with some components for the mechanical connection to the steering column, which means that it can be designed to be smaller on the whole than the first steering gear. A particularly light, compact and efficient steering system is consequently provided, which, in spite of the two steering gears, weighs no more, or even less, than the known electric steering systems which are based substantially on one steering gear in utility vehicle construction.

It is furthermore possible that the second steering gear is designed to be at least ca. 10%, preferably at least 20% and particularly preferably at least 25% smaller than the first steering gear in at least one dimension. As a result of this saving on installation space, other assemblies can be configured more flexibly and/or on a larger scale in the vehicle, since, within the context of autonomous driving, the function density in vehicles, and in particular in utility vehicles, continues to increase, with the required installation space remaining substantially constant. In this regard, a space-saving configuration of the steering system is particularly important and is addressed by reducing the size of the second steering gear in this way.

In addition, it may be provided that the first steering gear is coupled to at least one first electric motor, with the second steering gear being coupled to at least one second electric motor. In addition to the purely electromechanical steering assistance, this coupling is therefore particularly advantageous since, by means of the first and second electric motor, assistance functions of the steering system, for example lane keeping assist, (partly) autonomous steering, pre-collision assist and/or crosswind assist, can be implemented via the first and second steering gear. The two electric motors here may be connected to an, in particular central, control and/or regulating device of the vehicle or of the steering system (e.g. via a CAN bus, LIN bus and/or Ethernet), which, at the same time, processes the signals provided by the necessary sensors for the assistance systems and activates the two electric motors in response thereto. A particularly efficient, rapid and dynamic steering system is therefore provided.

It is furthermore contemplated that the second steering gear can be driven exclusively by the second electric motor. Moreover, the second electric motor can be activated independently of the first electric motor by the control and/or regulating device of the steering system. It is therefore particularly advantageously possible to dispense with additional hydraulic steering assistance, which involves additional installation space and costly components such as pumps, valves actuators and lines. Moreover, the control or regulation of the steering system is simplified since it is only necessary to activate the first and second electric motor and it is therefore possible to dispense with additional and costly control or regulation of the steering hydraulics.

It is likewise contemplated that the first steering gear has at least one mechanical through-drive, by means of which the first steering gear can be coupled to at least one steering column and to a vehicle steering wheel. An additional security level in the steering system is therefore provided, since, even in the worst case scenario, i.e. the failure of the first and second electric motor, a vehicle driver, using the vehicle steering wheel, may still safely control the vehicle mechanically via the steering system. In this case, the tensioning mechanism additionally serves as a driver, which simultaneously transmits the steering movements of the first steering gear or steering mechanism to the second steering gear or the second steering mechanism so that both vehicle wheels of a vehicle axle can still be steered properly. The vehicle axle may be a front axle of the vehicle or utility vehicle. However, it may additionally or alternatively also be a rear axle. The vehicle safety is consequently increased by the mechanical through-drive and a situation in which the vehicle cannot be steered may be avoided.

Further details and advantages of the invention shall now be explained in more detail with reference to an exemplary embodiment illustrated in the single drawing.

### BRIEF DESCRIPTION OF THE DRAWING

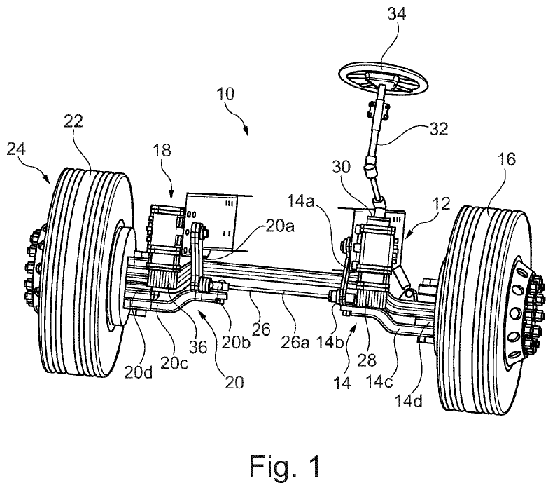

The single FIG. 1 shows a schematic perspective illustration of an exemplary embodiment of a steering system according to the invention.

### DETAILED DESCRIPTION OF THE DRAWING

FIG. 1 accordingly shows a steering system 10 for a vehicle (not illustrated in FIG. 1).

The vehicle is designed as a utility vehicle.

The steering system 10 comprises a first steering gear 12 and a first steering mechanism 14 for steering at least one first vehicle wheel 16.

The first steering gear 12 is furthermore coupled to the first steering mechanism 14.

The first steering mechanism 14 comprises a first steering rod 14a and a second steering rod 14, which are connected to each other via a swivel joint.

The second steering rod 14b is furthermore coupled, by means of a further swivel joint, to a track rod 14c, which in turn acts on the wheel carrier 14d for receiving and mounting the first vehicle wheel 16.

The first steering rod 14a is in turn coupled to an output shaft of the first steering gear 12 in a torsion-resistant manner.

A rotation of the output shaft of the first steering gear 12 is consequently transmitted to the first steering mechanism 14, whereby the track rod 14c thereof is pivoted, which results in a steering movement or turning of the first vehicle wheel 16.

Moreover, the steering system has a second steering gear 18 and a second steering mechanism 20 for steering a second vehicle wheel 22.

According to FIG. 1, the first steering gear 18 is coupled to the second steering mechanism 20.

The second steering mechanism 20 comprises a further first steering rod 20a and a second steering rod 20b, which are connected to each other via a swivel joint.

The second steering rod 20b is furthermore coupled, via further a swivel joint, to a further track rod 20c, which in turn acts on the wheel carrier 20d for receiving and mounting the second vehicle wheel 22.

The further first steering rod 20a is coupled to an output shaft of the second steering gear 18 in a torsion-resistant manner.

A rotation of this output shaft of the second steering gear 18 is consequently transmitted to the second steering mechanism 20 in such a way that the track rod 20c is pivoted, which results in a steering movement or turning of the second vehicle wheel 22.

The first and second steering gear 12, 18 are each fastened to a vehicle frame support (e.g. via a plurality of screw connections), wherein the output shaft of both steering gears 12, 18 extends through the vehicle frame support in each case and is coupled to the respective first steering rod 14a, 20a in a torsion-resistant manner.

In the present exemplary embodiment, the first and second vehicle wheel 16, 22 or the steering system 10 are associated with a front axle 24 of a utility vehicle.

Alternatively or additionally, the first and second vehicle wheel 16, 22 or the steering system 10 may also be associated with a rear axle of a utility vehicle.

The steering system furthermore has a tensioning mechanism 26, which is coupled to the first steering gear 12 and to the second steering gear 18.

According to FIG. 1, the tensioning mechanism may be designed as an elastically pre-tensionable and/or pre-tensioned tension rod, tie rod, tensioning strut, draw tube, tie beam or vise.

This coupling is realized in such a way that the first steering gear 12 and the second steering gear 18 are pre-tensionable with respect to each other.

In particular, it may be provided that the first steering gear 12 and the second steering gear 18 are pre-tensionable with respect to each other in the idle 18 state and oppositely.

The tensioning mechanism 26, in the mounted state, is therefore elastically pre-tensionable or may be pre-tensioned.

Moreover, the tensioning mechanism 26 is linked to the first steering mechanism 14 and to the second steering mechanism 20.

According to FIG. 1, the link is realized at the swivel joint between the second steering rod 14b, 20b and the respective track rod 14c, 20c in each case.

An opposite pre-tension means that, at the swivel joint between the second steering rod 14b, 20b and the respective track rod 14c, 20c in each case, the first and second steering mechanism 14, 20 are pressed apart elastically by the tensioning mechanism 26 by the amount for compensating or eliminating the steering play of the steering system 10.

In this case, the spacing between the two track rods 14c, 20c increases, amongst other things, at the swivel joint of the two second steering rods 14b, 20b in such a way that the steering play is removed.

In this connection, however, it may also alternatively be provided that an opposite pre-tension means that, at the swivel joint between the second steering rod 14b, 20b and the respective track rod 14c, 20c in each case, the first and second steering mechanism 14, 20 are pressed together elastically by the tensioning mechanism 26 by the amount for compensating or eliminating the steering play of the steering system 10.

In this case, the spacing between the two track rods 14c, 20c reduces in size, amongst other things, at the swivel joint of the two second steering rods 14b, 20b in such a way that the steering play is removed.

The tensioning mechanism 26 may furthermore have a longitudinal adjustment mechanism 26a.

The longitudinal adjustment mechanism 26a may be formed, for example, by two mutually axially displaceable linear guides, which are fastened to each other in the desired position (e.g. by one or more screw connections).

Additionally or alternatively, the tensioning mechanism 26 may comprise a telescopic mechanism.

The tensioning mechanism 26 may furthermore comprise an elastic spring element (not shown in FIG. 1).

The elastic spring element may be designed as an axial spring element.

The axial spring element here may be designed as an axial pressure spring element or as an axial tension spring element.

In this connection, as the axial pressure spring element, it is contemplated to use, in particular, helical pressure springs, diaphragm springs, disk springs, volute springs, annular springs, gas pressure springs or oil pressure springs.

In this regard, as the axial tension spring element, it is furthermore contemplated to use, in particular, helical tension springs and all further above-mentioned spring elements which are also suitable for use as axial tension springs.

The elastic spring element may furthermore be additionally or alternatively designed as a radial spring element.

In particular, leaf spring elements or rod spring elements are contemplated here.

According to FIG. 1, the second steering gear 18 is designed to be smaller than the first steering gear 12 in at least one dimension.

The second steering gear 18 is, in particular, designed to be at least ca. 10% smaller than the first steering gear 12 in one dimension.

The second steering gear 18 is, however, preferably designed to be at least 20% smaller than the first steering gear 12 in at least one dimension.

However, the second steering gear 18 is particularly preferably designed to be at least 25% smaller than the first steering gear 12 in at least one dimension.

According to FIG. 1, this dimension is, for example, the length of the two steering gears 12, 18.

However, it is additionally or alternatively contemplated that this dimension is also the width or the height of the two steering gears 12, 18.

The second steering gear 18 may furthermore also be designed to be smaller than the first steering gear 12 in two dimensions or in three dimensions.

The first steering gear 12 is furthermore coupled to a first electric motor 28.

The first electric motor 28 is flange-mounted on the first steering gear 12 and drives an internal spindle or ball screw, which then transmits its driving moment or steering moment to the first output shaft.

The first output shaft is in turn coupled to the first steering mechanism 14, so that the rotational movements of the output shaft are converted into steering movements of the first vehicle wheel 16.

The first steering gear 12 furthermore has a mechanical through-drive 30, via which the first steering gear 12 can be coupled to a steering column 32 and to a vehicle steering wheel 34.

The mechanical through-drive 30, like the first electric motor 28, is also connected to the spindle or ball screw in a torsion-resistant manner and drives this as a result of the manual steering movements of the vehicle steering wheel 34, generated by a vehicle driver, via the steering column 32.

According to FIG. 1, the second steering gear 18 is furthermore coupled to a second electric motor 36.

The second electric motor 36 is flange-mounted on the second steering gear 18 and drives a further internal spindle or ball screw, which then transmits the driving moment or steering moment to the second output shaft.

The second output shaft is in turn coupled to the second steering mechanism 20, so that the rotational movements of the output shaft are converted into steering movements of the second vehicle wheel 22.

As can furthermore be seen in FIG. 1, the second steering gear 18 can be driven exclusively by the second electric motor.

The second steering gear 18 is therefore not mechanically coupled to the steering column 32 or the vehicle steering wheel 34, but is driven only by the second electric motor 36.

The function of the steering system 10 can now be described as follows.

In normal operation, i.e. when all components of the steering system are functioning properly, a vehicle driver controls the steering system 10 via the vehicle steering wheel 34.

As soon as the vehicle driver controls the vehicle steering wheel 34 via a rotation, i.e. there is a relative change in the current angle of rotation, this rotation is, on the one hand, transmitted to the first steering gear 12 mechanically via the steering column 32.

The first steering gear 12 in turn transmits this rotation of the steering column 32 mechanically to the first steering mechanism 14, which in turn pivots or turns the first vehicle wheel 16 in a defined manner in response to the rotation at the vehicle steering wheel 34.

On the other hand, an angle-of-rotation sensor at the same time continuously detects the angle of rotation and the direction of rotation of the steering column 32 and/or the vehicle steering wheel 34 and transmits these values to a control and/or regulating device (not shown in FIG. 1) of the steering system 10 or of the utility vehicle.

Furthermore, at the same time, a torque sensor continuously detects the steering moment of the steering column 32 and/or the vehicle steering wheel 34 and likewise transmits these values to the control and/or regulating device.

On the basis of these values for the angle of rotation, direction of rotation and steering moment of the steering column 32 and/or vehicle steering wheel 34, the first and second electric motor 28, 36 are activated simultaneously and independently of each other by the control and/or regulating device with a minimum time lag from the manual mechanical steering movement (owing to the inertia of the system).

The two electric motors 28, 36 may thus activate the two steering gears 12, 18 independently of each other and simultaneously or synchronously with the manual mechanical activation via the vehicle steering wheel 34, thereby resulting in the steering assistance.

Play between the first and second steering gear 12, 18 is compensated as a result of the tensioning mechanism 26, which pre-tensions the first and second steering gear 12, 18 via the first and second steering mechanism 14, 20.

If the first and/or second electric motor 28, 36 fail(s), the tensioning mechanism 26 additionally serves as a driver to transmit the steering movements of the first steering mechanism 14 to the second steering mechanism 20 and vice versa.

However, the activation can still be ensured if only one electric motor 28, 36 is intact, since both electric motors 28, 36 may be activated independently of each other.

### LIST OF REFERENCE SIGNS

10 Steering system
12 First steering gear
14 First steering mechanism
14a First steering rod
14b Second steering rod
14c Track rod
14d Wheel carrier
16 First vehicle wheel
18 Second steering gear
20 Second steering mechanism
20a First steering rod
20b Second steering rod
20c Track rod
20d Wheel carrier
22 Second vehicle wheel
24 Front axle
26 Tensioning mechanism
26a Longitudinal adjustment mechanism
28 First electric motor
30 Mechanical through-drive
32 Steering column
34 Vehicle steering wheel
36 Second electric motor

1.-12. (canceled)

13. A steering system for a vehicle, comprising:
at least one first steering gear and at least one first steering mechanism for steering at least one first vehicle wheel, wherein the first steering gear is coupled to the first steering mechanism;
at least one second steering gear and at least one second steering mechanism for steering at least one second vehicle wheel, wherein the second steering gear is coupled to the second steering mechanism;
at least one tensioning mechanism coupled to the first steering gear and to the second steering gear such that the first steering gear and the second steering gear are pre-tensionable with respect to each other, in an idle state and oppositely.

14. The steering system as claimed in claim 13, wherein
the tensioning mechanism is linked to the first steering mechanism and to the second steering mechanism.

15. The steering system as claimed in claim 13, wherein
the tensioning mechanism, in a mounted state, is elastically pre-tensionable and/or pre-tensioned.

16. The steering system as claimed in claim 13, wherein
the tensioning mechanism comprises at least one longitudinal adjustment mechanism and/or telescopic mechanism.

17. The steering system as claimed in claim 13, wherein
the tensioning mechanism comprises at least one elastic spring.

18. The steering system as claimed in claim 17, wherein
the elastic spring is an axial spring.

19. The steering system as claimed in claim 17, wherein
the elastic spring is a radial spring.

20. The steering system as claimed in claim 19, wherein
the radial spring is a leaf spring.

21. The steering system as claimed in claim 13, wherein
the second steering gear is designed to be smaller than the first steering gear in at least one dimension.

22. The steering system as claimed in claim 21, wherein
the second steering gear is designed to be at least about 10% smaller than the first steering gear in at least one dimension.

23. The steering system as claimed in claim 21, wherein
the second steering gear is designed to be at least about 20% smaller than the first steering gear in at least one dimension.

24. The steering system as claimed in claim 21, wherein
the second steering gear is designed to be at least about 25% smaller than the first steering gear in at least one dimension.

25. The steering system as claimed in claim 13, wherein
the first steering gear is coupled to at least one first electric motor, with the second steering gear being coupled to at least one second electric motor.

26. The steering system as claimed in claim 25, wherein
the second steering gear is drivable exclusively by the second electric motor.

27. The steering system as claimed in claim 13, wherein
the first steering gear has at least one mechanical through-drive, via which the first steering gear is couplable to at least one steering column and to a vehicle steering wheel.
